(19) United States
(12) Patent Application Publication
(10) Pub. No.: US 2026/0343389 A1
(43) Pub. Date: Oct. 29, 2026

(54) REDUCED SYSTEM INFORMATION FOR NETWORK ENERGY SAVING

(71) Applicant: Fraunhofer-Gesellschaft zur Förderung der angewandten Forschung e.V., München (DE)

(72) Inventors: Gustavo Wagner OLIVEIRA DA COSTA, Erlangen (DE); Geordie GEORGE, Erlangen (DE); Nazanin VATANIAN, Erlangen (DE); Elke ROTH-MANDUTZ, Erlangen (DE); Martin LEYH, Erlangen (DE); Julian POPP, Erlangen (DE)

(73) Assignee: Fraunhofer-Gesellschaft zur Förderung der angewandten Forschung e.V., München (DE)

(21) Appl. No.: 19/701,578

(22) Filed: Jun. 8, 2026

Related U.S. Application Data
(63) Continuation of application No. PCT/EP2024/085132, filed on Dec. 6, 2024.

(30) Foreign Application Priority Data
Dec. 8, 2023 (EP) 23215316.3

(51) Int. Cl. H04W 48/16; H04W 56/00; H04W 72/232; H04W 88/10

(52) U.S. Cl. CPC H04W 48/16; H04W 56/00; H04W 72/232; H04W 88/10

(57) ABSTRACT

A base station for a wireless communication network is provided, wherein the base station is configured to serve a first part of the network, wherein the base station is configured to transmit a second part access information for enabling a user equipment to access a second part of the network.

### CROSS-REFERENCE TO RELATED APPLICATION

This application claims priority from European Patent Application No. 23215316.3, which was filed on Dec. 8, 2023, and is incorporated herein in its entirety by reference.

### BACKGROUND OF THE INVENTION

Embodiments of the present application relate to the field of wireless communication, and more specifically, to network energy saving. Some embodiments relate to reduced system information, SI, for network energy saving.

FIG. 1 is a schematic representation of an example of a terrestrial wireless network 100 including, as is shown in FIG. 1A, a core network 102 and one or more radio access networks (RANs) RAN₁, RAN₂, . . . RAN_{N}. FIG. 1B is a schematic representation of an example of a radio access network RANₙ that may include one or more base stations (BSs) gNB₁ to gNB₅, each serving a specific area surrounding the base station schematically represented by respective cells 106₁ to 106₅. The base stations are provided to serve users within a cell. The term base station, BS, refers to a next generation node B (gNB) in 5G networks, an evolved node B (eNB) in UMTS/LTE/LTE-A/LTE-A Pro, or just a BS in other mobile communication standards. A user may be a stationary device or a mobile device. The wireless communication system may also be accessed by mobile or stationary Internet of Things (IoT) devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANₙ may include more or less such cells, and RANₙ may also include only one base station. FIG. 1B shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. Further, FIG. 1B shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1B by the arrows pointing to “core”. The core network 102 may be connected to one or more external networks. Further, some or all of the respective base station gNB₁ to gNB₅ may connected, e.g., via the S1 or X2 interface or the XN interface in NR, with each other via respective backhaul links 116₁ to 116₅, which are schematically represented in FIG. 1B by the arrows pointing to “gNBs”.

For data transmission a physical resource grid may be used. The physical resource grid may comprise a set of resource elements (REs) to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 orthogonal frequency-division multiplexing (OFDM) symbols depending on the cyclic prefix (CP) length. All OFDM symbols may be used for downlink (DL) or uplink (UL) or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the OFDM system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1.

This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in a radio resource control (RRC) connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex (TDD) systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

Wireless network deployments are becoming increasingly more complex. In particular, public networks deployed by cellular operators rely on multiple bands, each with different coverage and potentially different deployment strategies. The main synchronization signals and system information (SI), which is needed for the UEs to access the network, is broadcast by the network. Due to the support of multi-frequency deployment and beamforming, SI is typically sent on every frequency and direction to guarantee it can reach the UE. However, this leads not only to a lot of overhead but a large gNB power consumption even when there is no traffic present at all.

Therefore, there is the need for improvements or enhancements with respect to the gNB power consumption caused by broadcasting synchronization signals and system information.

It is noted that the information in the above section is only for enhancing the understanding of the background of the invention and therefore it may contain information that is not conventional technology and is already known to a person of ordinary skill in the art.

### SUMMARY

An embodiment may have a base station for a wireless communication network, wherein the base station is configured to serve a first part of the network, wherein the base station is configured to transmit a second part access information for enabling a user equipment to access a second part of the network.

Another embodiment may have a user equipment for a wireless communication network, wherein the user equipment is configured to receive from a base station on a first part of the network a second part access information, wherein the second part access information enables the UE to access the second part of the network.

According to another embodiment, a method for operating a base station for a wireless communication network may have the steps of: serving a first part of the network; transmitting a second part access information for enabling a user equipment to access a second part of the network.

According to another embodiment, a method for operating a user equipment for a wireless communication network may have the step of: receiving from a base station on a first part of the network a second part access information, wherein the second part access information enables the UE to access the second part of the network.

Another embodiment may have a non-transitory digital storage medium having a computer program stored thereon to perform any of the inventive methods when said computer program is run by a computer.

### BRIEF DESCRIPTION OF THE DRAWINGS

Embodiments of the present invention will be detailed subsequently referring to the appended drawings, in which:

FIG. 1A is a schematic representation of an example of a terrestrial wireless network;

FIG. 1B is a schematic representation of an example of a radio access network RANₙ that may include one or more base stations;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 is a schematic representation of a wireless communication system comprising a transceiver, like a base station or a relay, and a plurality of communication devices, like UEs, according to an embodiment;

FIG. 7 is a schematic illustration of an example of system information block one, SIB-1, and cross-carrier minimum system information, x-MSI, allocation with a single downlink control information, DCI;

FIG. 8 is a schematic representation of a hybrid operation where part of the system information block one, SIB-1, (of non-anchor cell) is sent on anchor cell, but another part which is specific to each beam is sent directly on non-anchor cell—beamformed on each direction; and

FIG. 9 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

As indicated above, wireless network deployments are becoming increasingly more complex. In particular, public networks deployed by cellular operators rely on multiple bands, each with different coverage and potentially different deployment strategies. The main synchronization signals and system information (SI), which is needed for the UEs to access the network, is broadcast by the network. Due to the support of multi-frequency deployment and beamforming, SI is typically sent on every frequency and direction to guarantee it can reach the UE. However, this leads not only to a lot of overhead but a large gNB power consumption even when there is no traffic present at all, as will become clear from the following discussion.

In 5G NR the synchronization signals, e.g., primary synchronization signal (PSS) and secondary synchronization signal (SSS), physical broadcast channel/master information block (PBCH/MIB) and system information block one (SIB-1) are (e.g., absolutely essential for UEs being able to access the network. The PSS, SSS and PBCH/MIB form SSBs. MIB+SIB-1 is also called the minimum system information (MSI) and SIB-1 is called remaining minimum system information (RMSI). The “minimum” in MSI already documents that this information is essential for a UE to access the network (e.g., information for initial random access) and it should reach every UE. Because of that SSB and SIB-1 are typically broadcast in every frequency and within each frequency on every beamformed direction, which may be up to four, eight or even 64 directions depending on the operation band. All these transmissions consume a lot of energy and in the case no UE is actually listening to them (e.g., low traffic) it amounts to a large energy waste.

In order to enable network energy savings (NES), [1] describes operations in a multi-carrier scenario, where in some frequencies the cells may operate without SSBs or without SIBs. For that sake, the following is defined:
An anchor cell is a cell where SSBs, paging and system information are sent.
A non-anchor cell without SIB, or SIB-less cell, is a cell where the cell is not transmitting SIB.
A non-anchor cell without SIB or SSB, or SSB-less cell, is a cell where the cell is transmitting neither SSB nor SIB.

In this context, there are two main models to perform initial access:
The initial access occurs only via anchor cell, which means that non-anchor cells are only accessible on later stages, e.g., when the UE is already on RRC_CONNECTED mode and receives dedicated signaling.
The access may be done directly from non-anchor cell. In this case, the information needed to access the non-anchor cell is transmitted on the anchor cell. However, TR 38.864 [1] does not define what such access information should be.

Simulation results captured in [1] show energy savings from SSB-less and/or SIB-less operation, but it also shows a considerable increase in energy consumption on the anchor cell when the access information of one non-anchor cell is transmitted in the anchor cell. Real deployments work not only with two frequencies but even more (e.g., four, five, six) frequencies and this effect on the anchor carrier may be much worse than documented at [1]. Clearly, there is a large room for improvement over the solutions described in [1].

The ASN.1 definition for SIB-1 looks like shown in the following [3]. Thereby, in the below definition, the relevant section is underlined:

| SIB1 ::= | SEQUENCE { | |
|---|---|---|
| cellSelectionInfo | | SEQUENCE { |
| q-RxLevMin | Q-RxLevMin, | |
| q-RxLevMinOffsetINTEGER (1..8) | | OPTIONAL, -- Need S |
| q-RxLevMinSUL | Q-RxLevMin | OPTIONAL, -- Need R |
| q-QualMin | Q-QualMin | OPTIONAL, -- Need S |

| | |
|---|---|
| q-QualMinOffset INTEGER (1..8) | OPTIONAL -- Need S |

| | |
|---|---|
| } | OPTIONAL, -- Cond Standalone |

| cellAccessRelatedInfo | CellAccessRelatedInfo, | |
|---|---|---|
| connEstFailureControl | ConnEstFailureControl | OPTIONAL, -- Need R |
| si-SchedulingInfo | SI-SchedulingInfo | OPTIONAL, -- Need R |
| servingCellConfigCommon | ServingCellConfigCommonSIB | OPTIONAL, -- |

Need R

| | | |
|---|---|---|
| ims-EmergencySupport | ENUMERATED {true} | OPTIONAL, -- Need R |
| eCallOverIMS-Support | ENUMERATED {true} | OPTIONAL, -- Need R |
| ue-TimersAndConstants | UE-TimersAndConstants | OPTIONAL, -- Need R |

uac-BarringInfo SEQUENCE {

| | | |
|---|---|---|
| uac-BarringForCommon | UAC-BarringPerCatList | OPTIONAL, -- Need S |
| uac-BarringPerPLMN-List | UAC-BarringPerPLMN-List | OPTIONAL, -- Need S |

| | |
|---|---|
| uac-BarringInfoSetList | UAC-BarringInfoSetList, |

uac-AccessCategory1-SelectionAssistanceInfo CHOICE {

| | |
|---|---|
| plmnCommon | UAC-AccessCategory1-SelectionAssistanceInfo, |

| | |
|---|---|
| individualPLMNList | SEQUENCE (SIZE (2..maxPLMN)) OF UAC- |

AccessCategory1-SelectionAssistanceInfo

| } | OPTIONAL -- Need S | |
|---|---|---|
| } | OPTIONAL, -- Need R | |
| useFullResumeID | ENUMERATED {true} | OPTIONAL, -- Need R |

| | | |
|---|---|---|
| lateNonCriticalExtension | OCTET STRING | OPTIONAL, |
| nonCriticalExtension | SIB1-v1610-IEs | OPTIONAL |

}

| | |
|---|---|
| SIB1-v1610-IEs ::= | SEQUENCE { |

| | | |
|---|---|---|
| idleModeMeasurementsEUTRA-r16 | ENUMERATED{true} | OPTIONAL, -- Need R |
| idleModeMeasurementsNR-r16 | ENUMERATED{true} | OPTIONAL, -- Need R |
| posSI-SchedulingInfo-r16 | PosSI-SchedulingInfo-r16 | OPTIONAL, -- Need R |
| nonCriticalExtension | SIB1-v1630-IEs | OPTIONAL |

}

| | |
|---|---|
| SIB1-v1630-IEs ::= | SEQUENCE { |

| | |
|---|---|
| uac-Barring Info-v1630 | SEQUENCE { |
| uac-AC1-SelectAssistInfo-r16 | SEQUENCE (SIZE (2..maxPLMN)) OF UAC-AC1- |

SelectAssistInfo-r16

| | |
|---|---|
| } | OPTIONAL, -- Need R |

| | | |
|---|---|---|
| nonCriticalExtension | SIB1-v1700-IEs | OPTIONAL |

}

| SIB1-v1700-IEs ::= | SEQUENCE { | |
|---|---|---|
| hsdn-Cell-r17 | ENUMERATED {true} | OPTIONAL, -- Need R |

| | |
|---|---|
| uac-BarringInfo-v1700 | SEQUENCE { |
| uac-BarringInfoSetList-v1700 | UAC-BarringInfoSetList-v1700 |

| | |
|---|---|
| } | OPTIONAL, -- Cond MINT |

| sdt-ConfigCommon-r17 | SDT-ConfigCommonSIB-r17OPTIONAL, -- Need R | |
|---|---|---|
| redCap-ConfigCommon-r17 | RedCap-ConfigCommonSIB-r17 | OPTIONAL, - |

- Need R

| | |
|---|---|
| featurePriorities-r17 | SEQUENCE { |

| | | |
|---|---|---|
| redCapPriority-r17 | FeaturePriority-r17 | OPTIONAL, -- Need R |

| | | |
|---|---|---|
| slicingPriority-r17 | FeaturePriority-r17 | OPTIONAL, -- Need R |

| | | |
|---|---|---|
| msg3-Repetitions-Priority-r17 | FeaturePriority-r17 | OPTIONAL, -- Need R |

| | | |
|---|---|---|
| sdt-Priority-r17 | FeaturePriority-r17 | OPTIONAL -- Need R |

| | |
|---|---|
| } | OPTIONAL, -- Need R |

| | | |
|---|---|---|
| si-SchedulingInfo-v1700 | SI-SchedulingInfo-v1700 | OPTIONAL, -- Need R |

| | | |
|---|---|---|
| hyperSFN-r17 | BIT STRING (SIZE (10)) | OPTIONAL, -- Need R |

| | | |
|---|---|---|
| eDRX-AllowedIdle-r17 | ENUMERATED {true} | OPTIONAL, -- Need R |
| eDRX-AllowedInactive-r17 | ENUMERATED {true} | OPTIONAL, -- Cond |
| | | EDRX-RC |
| intraFreqReselectionRedCap-r17 | ENUMERATED {allowed, notAllowed} | OPTIONAL, |

-- Need S

| | | |
|---|---|---|
| cellBarredNTN-r17 | ENUMERATED {barred, notBarred} | OPTIONAL, -- Need S |
| nonCriticalExtension | SIB1-v1740-IEs | OPTIONAL |

}

| | |
|---|---|
| SIB1-v1740-IEs ::= | SEQUENCE { |

| | | |
|---|---|---|
| si-SchedulingInfo-v1740 | SI-SchedulingInfo-v1740 | OPTIONAL, -- Need R |
| nonCriticalExtension | SEQUENCE { } | OPTIONAL |

}

| | |
|---|---|
| UAC-AccessCategory1-SelectionAssistanceInfo ::= | ENUMERATED {a, b, c} |

| | |
|---|---|
| UAC-AC1-SelectAssistInfo-r16 ::= | ENUMERATED {a, b, c, notConfigured} |
| SDT-ConfigCommonSIB-r17 ::= | SEQUENCE { |
| sdt-RSRP-Threshold-r17 | RSRP-Range OPTIONAL, -- Need R |
| sdt-LogicalChannelSR-DelayTimer-r17 | ENUMERATED { sf20, sf40, sf64, sf128, sf512, sf1024, |

sf2560, spare1} OPTIONAL, -- Need R

| | |
|---|---|
| sdt-DataVolumeThreshold-r17 | ENUMERATED {byte32, byte100, byte200, byte400, |

byte600, byte800, byte1000, byte2000, byte4000,
byte8000, byte9000, byte10000, byte12000, byte24000, byte48000, byte96000},

| | |
|---|---|
| t319a-r17 | ENUMERATED { ms100, ms200, ms300, ms400, ms600, ms1000, ms2000, |

ms3000, ms4000, spare7, spare6, spare5, spare4, spare3, spare2, spare1}
}
RedCap-ConfigCommonSIB-r17 ::= SEQUENCE {

| | | |
|---|---|---|
| halfDuplexRedCapAllowed-r17 | ENUMERATED {true} | OPTIONAL, -- Need R |

| | |
|---|---|
| cellBarredRedCap-r17 | SEQUENCE { |
| cellBarredRedCap1Rx-r17 | ENUMERATED {barred, notBarred}, |
| cellBarredRedCap2Rx-r17 | ENUMERATED {barred, notBarred} |

| | |
|---|---|
| } | OPTIONAL, -- Need R |

...
}

| CellAccessRelatedInfo ::= | SEQUENCE { | |
|---|---|---|
| plmn-IdentityInfoList | PLMN-IdentityInfoList, | |
| cellReservedForOtherUse | ENUMERATED {true} | OPTIONAL, -- Need R |

```
  ...,
  [[
```

| | | |
|---|---|---|
| cellReservedForFutureUse-r16 | ENUMERATED {true} | OPTIONAL, -- Need R |
| npn-IdentityInfoList-r16 | NPN-IdentityInfoList-r16 | OPTIONAL -- Need R |

```
  ]],
  [[
```

| | |
|---|---|
| snpn-AccessInfoList-r17 | SEQUENCE (SIZE (1..maxNPN-r16)) OF SNPN-AccessInfo- |

r17 OPTIONAL -- Need R
]]
}

| SNPN-AccessInfo-r17 ::= | SEQUENCE { | |
|---|---|---|
| extCH-Supported-r17 | ENUMERATED {true} | OPTIONAL, -- Need R |
| extCH-WithoutConfigAllowed-r17 | ENUMERATED {true} | OPTIONAL, -- Need R |
| onboardingEnabled-r17 | ENUMERATED {true} | OPTIONAL, -- Need R |
| imsEmergencySupportForSNPN-r17 | ENUMERATED {true} | OPTIONAL -- Need R |

}

Below described embodiments reduce the gNB power consumption caused by broadcasting of synchronization signals and system information.

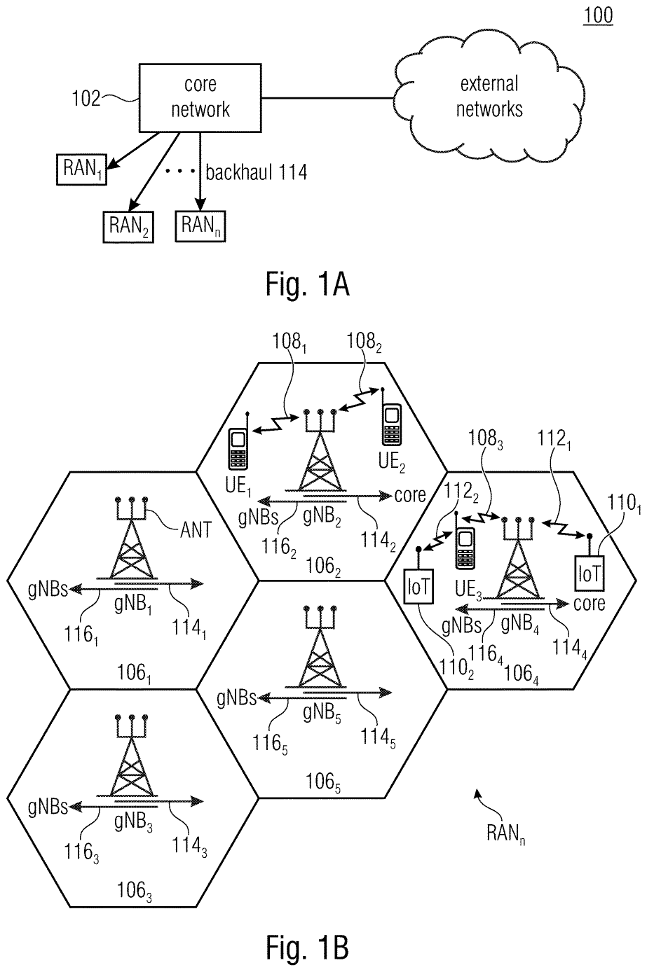

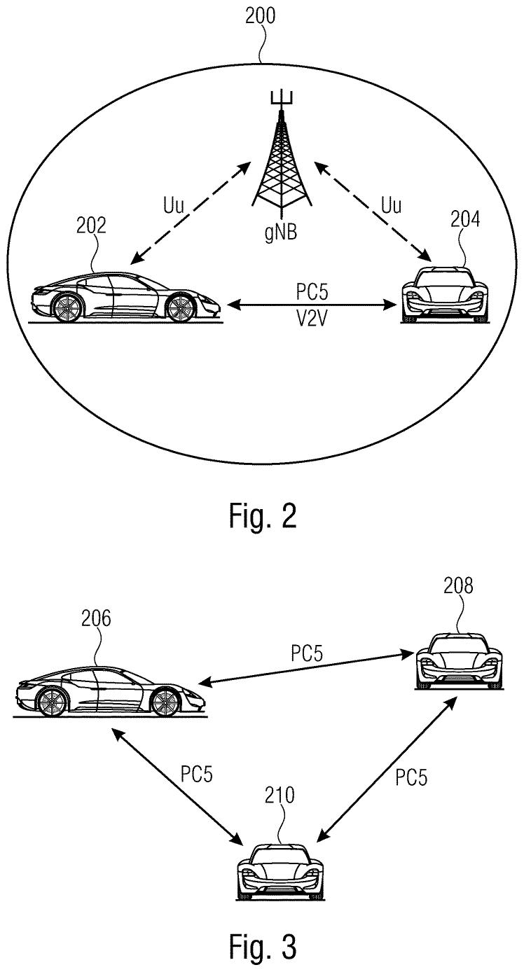

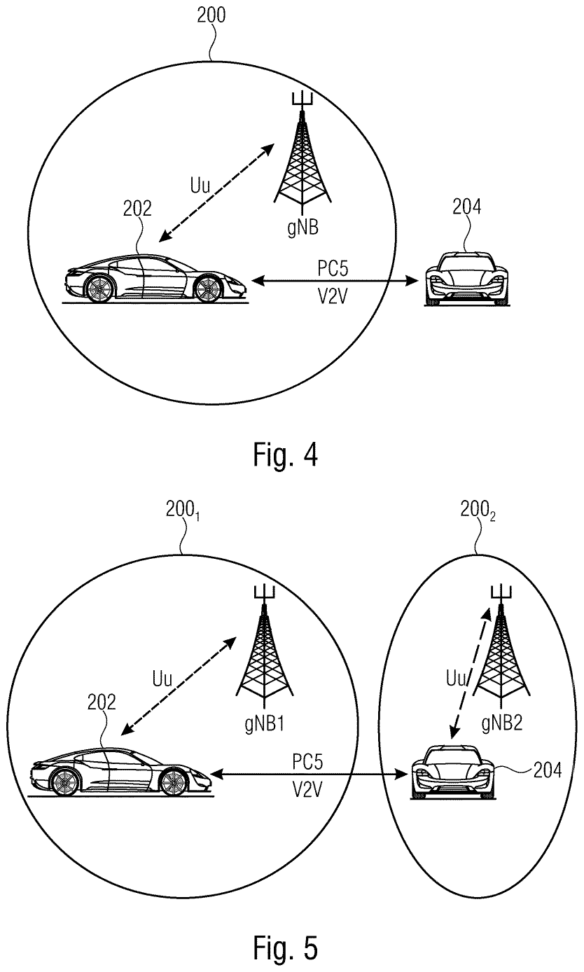

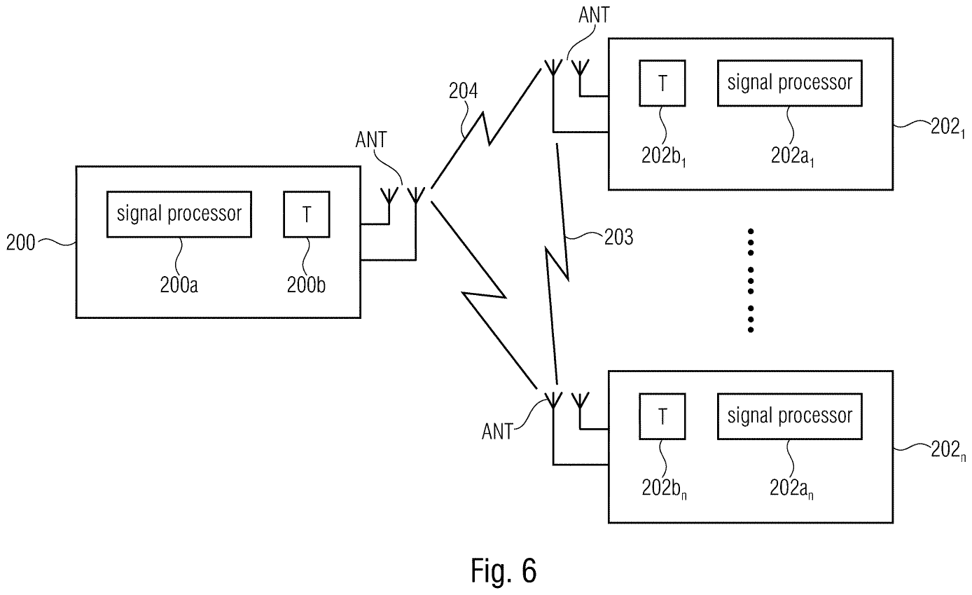

Embodiments of the present invention may be implemented in a wireless communication system or network as depicted in FIGS. 1 to 5 including a transceiver, like a base station, gNB, or relay, and a plurality of communication devices, like user equipment's, UEs. FIG. 6 is a schematic representation of a wireless communication system comprising a transceiver 200, like a base station, and a plurality of communication devices 202₁ to 202ₙ, like UEs. The UEs might communicate directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a₁ to 202aₙ, and a transceiver (e.g., receiver and/or transmitter) unit 202b₁ to 202bₙ. The base station 200 and/or the one or more UEs 202 may operate in accordance with the inventive teachings described herein.

Embodiments provide a base station [e.g., gNB] for a [e.g., 5G/NR] wireless communication network, wherein the base station is configured to serve a first part of the network [e.g., cell/carrier/beam] [e.g., anchor cell], wherein the base station is configured to [e.g., in the first part of the network; e.g., using resources of the first part of the network] to transmit a second part access information [e.g., x-MSI] for enabling a user equipment to [e.g., initially] access a second part of the network [e.g., non-anchor cell].

In embodiments, the second access information is essential for an initial access of a UE to the second part of the network.

In embodiments, the second part access information describes at least a part of system information [e.g., master information block, MIB, and/or system information block one, SIB-1] of the second part of the network.

In embodiments, the first part of the network is at least one out of a first cell, anchor cell, first carrier and first beam.

In embodiments, the second part of the network is at least one out of a second cell [e.g., different from the first cell], non-achor cell, second carrier [e.g., different from the first carrier] and second beam [e.g., different from the first beam].

In embodiments, the second part access information describes a timing and/or frequency of a synchronization signal [e.g., synchronization signal block, SSB] of the second part of the network.

In embodiments, the base station is configured to transmit a system information [e.g., master information block, MIB, and/or system information block one, SIB-1] of the first part of the network.

In embodiments, the second part access information [e.g., only] describes a difference [e.g., via differential encoding or delta information] between
at least the part of the system information [e.g., master information block, MIB, and/or system information block one, SIB-1] of the second part of the network, and
at least a corresponding part of the system information [e.g., master information block, MIB, and/or system information block one, SIB-1] of the first part of the network.

In embodiments, the base station is configured to transmit the second part access information with a lower transmit power than the system information [e.g., master information block, MIB, and/or system information block one, SIB-1] of the first part of the network.

In embodiments, the base station is configured to transmit
the second cell access information, and
the system information [e.g., master information block, MIB, and/or system information block one, SIB-1] of the first part of the network
   using frequency domain multiplexing.

In embodiments, the base station is configured to transmit
the system information [e.g., master information block, MIB, and/or system information block one, SIB-1] of the first part of the network in a first bandwidth part [or resource block], and
the second cell access information using a second bandwidth part [or resource block], different from the first bandwidth part.

In embodiments, the base station is configured to transmit
the system information [e.g., master information block, MIB, and/or system information block one, SIB-1] of the first cell, and
the second cell access information
   on the same bandwidth part [or resource block], but using different search spaces.

In embodiments, the base station is configured to transmit a downlink control information, DCI, indicating a [e.g., contiguous] group of resource blocks used for transmitting
the system information [e.g., master information block, MIB, and/or system information block one, SIB-1] of the first part of the network, and
the second part access information.

In embodiments, the downlink control information, DCI, indicates the group of resource blocks by means of a start resource block and a number of contiguous resource blocks of the group of resource blocks.

In embodiments, the downlink control information, DCI, contains an indication that the second cell access information is transmitted on one [e.g., a (proper) subset] of the resource blocks of the group of resource blocks.

In embodiments, a presence or absence of a subset of resource blocks is indicated by means of a one bit indication.

In embodiments, the second part access information [e.g., only] describes the information [e.g., those fields] of the system information [e.g., master information block, MIB, and/or system information block one, SIB-1] of the second part of the network, which is different from the system information [e.g. master information block, MIB, and/or system information block one, SIB-1] of the first part of the network.

In embodiments, the second part access information describes at least a part of a system information [e.g., master information block, MIB, and/or system information block one, SIB-1] of at least two different second parts of the network.

In embodiments, the second part access information [e.g., only] describes the information [e.g., those fields] of the system information [e.g., master information block, MIB, and/or system information block one, SIB-1] of the at least two different second parts of the network, which are different from the system information [e.g., master information block, MIB, and/or system information block one, SIB-1] of the first part of the network.

In embodiments, the second part access information describes the information that is common to the system information [e.g., master information block, MIB, and/or system information block one, SIB-1] of the at least two different second parts of the network only once.

In embodiments, the base station is configured to transmit the second part access information [e.g., only] in response to a second part access information transmission request [e.g., received from a UE] and/or in case that a second part access information transmission criterion is fulfilled.

In embodiments, the second part access information transmission criterion is fulfilled in case that at least one out of
a load of the first part of the network reaches a predefined load condition [e.g., crosses/exceeds/falls below a load threshold],
a signal strength of the first part of the network and/or second part of the network reaches a predefined signal strength condition [e.g., crosses/exceeds/falls below a signal strength threshold].

In embodiments, the base station is configured to serve the second part of the network, wherein the base station is configured to operate the second part of the network in an energy saving mode of operation, wherein in the energy saving mode of operation the system information [e.g., master information block, MIB, and/or system information block one, SIB-1] of the second part of the network is not transmitted or transmitted only partially in the second part of the network [e.g., using resources of the second part of the network].

In embodiments, the base station is configured to operate the first part of the network in one out of frequency range one, FR1, and frequency range two, FR2, wherein the base station is configured operate the second part of the network in the other one out of frequency range one, FR1, and frequency range two, FR2.

In embodiments, the second part access information is transmitted as part of a container [e.g. comprising second part access information of at least two different second parts of the network [e.g., two or more or even all non-anchor cells]].

In embodiments, the second part access information is a system information block.

For example, a SIB container [e.g., SIB-XY] can include xMSI from all other cells.

In embodiments, the base station is configured to transmit a second part access information transmission request configuration information [e.g., SI-RequestConfig] [e.g., on a single resource] allowing a user equipment to transmit a second part access information transmission request.

For example, a single resource [e.g., an SI-RequestConfig] can be present so that UE can request if SIB-XY is on notBroadcasting status.

In embodiments, the base station is configured to transmit a first part of the system information [e.g., master information block, MIB, and/or system information block one, SIB-1] of the second part of the network in the second part of the network, wherein the second part access information describes a second part [e.g., different from the first part] of the system information [e.g., master information block, MIB, and/or system information block one, SIB-1] of the second part of the network.

In embodiments, the first part of the system information [e.g., master information block, MIB, and/or system information block one SIB-1] of the second part of the network includes beam specific information, wherein the second part of the system information [e.g., master information block, MIB, and/or system information block one, SIB-1] of the second part of the network includes non-beam specific information.

In embodiments, the base station is configured transmit the first part of the system information [e.g., master information block, MIB, and/or system information block one, SIB-1] of the second part of the network using a beam sweep.

In embodiments, the beam specific information includes one or more out of synchronization signal block, SSB, positions-in-burst, random access control channel, RACH, time information and random access control channel, RACH, frequency information.

In embodiments, the beam specific information is transmitted via an extension of the master information block, MIB, or on a downlink control information, DCI, in the common physical downlink control channel, PDCCH, signaling, or on a physical downlink shared channel.

In embodiments, the second part of the system information [e.g., master information block, MIB, and/or system information block one SIB-1] of the second part of the network includes a timing information for at least one synchronization signal block, SSB, of the second part of the network.

In embodiments, the second part of the system information [e.g., master information block, MIB, and/or system information block one SIB-1] of the second part of the network includes a correspondence of the timing information for at least one synchronization signal block, SSB, of the second part of the network with synchronization signal block, SSB, positions in burst.

In embodiments, the second part of the system information [e.g., master information block, MIB, and/or system information block one SIB-1] of the second part of the network includes a correspondence of the timing information for at least one synchronization signal block, SSB, of the second part of the network with a list of random access channel, RACH, configurations where the same beamforming direction can be assumed.

In embodiments, the base station is configured to transmit second part radio resource management assistance information for enabling a user equipment to access a second part of the network [e.g., non-anchor cell], wherein the second part radio resource management assistance information describes radio resource management information of the second part of the network.

In embodiments, the radio resource management information of the second part of the network includes one or more out of
a reference signal configuration of the second cell,
E-UTRA absolute radio frequency channel number, EARFCN, and a number of resource blocks,
an ID of the second cell,
a time alignment offset between the first cell and the second cell,
at least one parameter for frequency correction.

Embodiments provide an user equipment for a [e.g., 5G/NR] wireless communication network, wherein the user equipment is configured to receive from a base station on a first part of the network [e.g., cell/carrier/beam][e.g., anchor cell] a second part access information [e.g., x-MSI], wherein the second part access information enables the UE to access the second part of the network.

In embodiments, the second access information is essential for an initial access of the user equipment to the second part of the network.

In embodiments, the second part access information describes at least a part of a system information [e.g., master information block, MIB, and/or system information block one, SIB-1 or any combination of the master information block, MIB, and system information block one, SIB-1] of the second part of the network.

In embodiments, user equipment is configured to access the second part of the network based on the second part access information.

In embodiments, the user equipment is configured to receive from the base station on the first part of the network a system information [e.g., master information block, MIB, and/or system information block one, SIB-1] of the first part of the network.

In embodiments, the second part access information [e.g., only] describes a difference [e.g., via differential encoding or delta information] between
at least the part of the system information [e.g., master information block, MIB, and/or system information block one, SIB-1] of the second part of the network, and
at least a corresponding part of the system information [e.g., master information block, MIB, and/or system information block one, SIB-1] of the first part of the network.

In embodiments, the second part access information is transmitted with a lower transmit power than the system information [e.g., master information block, MIB, and/or system information block one, SIB-1] of the first part of the network.

In embodiments, the user equipment is configured to access the first part of the network or the second part of the network in dependence on an access criterion.

For example, the user equipment can be configured to access the second part of the network instead of the first part of the network in case that a received signal power of the first part of the network and/or second part of the network is above a threshold.

In embodiments, the access criterion is one out of
a received signal power of the first part of the network,
a received signal power of the second part of the network,
a difference between a received signal power of the first part of the network and a received signal power of the second part of the network.

In embodiments, the first part of the network is a first cell, first carrier and/or first beam.

In embodiments, the second part of the network is a second cell, second carrier and/or second beam.

In embodiments, the user equipment is configured to receive
the second part access information, and
the system information [e.g., master information block, MIB, and/or system information block one, SIB-1] of the first part of the network
   using frequency domain multiplexing.

In embodiments, the user equipment is configured to receive
the system information [e.g., master information block, MIB, and/or system information block one, SIB-1] of the first part of the network in a first bandwidth part [or resource block], and
the second part access information using a second bandwidth part [or resource block], different from the first bandwidth part.

In embodiments, the user equipment is configured to receive
the system information [e.g., master information block, MIB, and/or system information block one, SIB-1] of the first part of the network, and
the second part access information
   on the same bandwidth part [or resource block], but using different search spaces.

In embodiments, the user equipment is configured to receive a downlink control information, DCI, indicating a [e.g., contiguous] group of resource blocks used for transmitting
the system information [e.g., master information block, MIB, and/or system information block one, SIB-1] of the first part of the network, and
the second part access information.

In embodiments, the downlink control information, DCI, indicates the group of resource blocks by means of a start resource block and a number of contiguous resource blocks of the group of resource blocks.

In embodiments, the downlink control information, DCI, contains an indication that the second part access information is transmitted on one of the resource blocks of the group of resource blocks.

In embodiments, a presence or absence of a subset of resource blocks is indicated by means of a one bit indication.

In embodiments, the second part access information [e.g., only] describes the information [e.g., those fields] of the system information [e.g., master information block, MIB, and/or system information block one, SIB-1] of the second part of the network, which is different from the system information [e.g., master information block, MIB, and/or system information block one, SIB-1] of the first part of the network.

In embodiments, the second part access information describes at least a part of a system information [e.g., master information block, MIB, and/or system information block one, SIB-1] of at least two different second parts of the network.

In embodiments, the second part access information [e.g., only] describes the information [e.g., those fields] of the system information [e.g., master information block, MIB, and/or system information block one, SIB-1] of the at least two different second parts of the network, which are different from the system information [e.g., master information block, MIB, and/or system information block one, SIB-1] of the first part of the network.

In embodiments, the second part access information describes the information that is common to the system information [e.g., master information block, MIB, and/or system information block one, SIB-1] of the at least two different second parts of the network only once.

In embodiments, the user equipment is configured to transmit to the base station on the first part of the network a second part access information transmission request, wherein the user equipment is configured to receive the second part access information in response to the transmission of the second part access information transmission request.

In embodiments, the second part access information is transmitted as part of a container [e.g. comprising second part access information of at least two different second parts of the network [e.g., two or more or even all non-anchor cells]].

In embodiments, the second part access information is a system information block.

For example, a SIB container [e.g., SIB-XY] can include xMSI from all other cells.

In embodiments, the user equipment is configured to receive a second part access information transmission request configuration information [e.g., SI-RequestConfig] [e.g., on a single resource], wherein the user equipment is configured to transmit to the base station on the first part of the network a second part access information transmission request in dependence on the second part access information transmission request configuration information [e.g., SI-RequestConfig].

For example, a single resource [e.g., an SI-RequestConfig] can be present so that UE can request if SIB-XY is on notBroadcasting status.

In embodiments, the second part access information describes a second part [e.g., different from the first part] of the system information [e.g., master information block, MIB, and/or system information block one, SIB-1] of the second cell, wherein the user equipment is configured to receive a first part of the system information [e.g., master information block, MIB, and/or system information block one, SIB-1] of the second part of the network in the second part of the network.

In embodiments, the user equipment is configured to combine the first part of the system information [e.g., master information block, MIB, and/or system information block one, SIB-1] of the second part of the network and the second part [e.g., different from the first part] of the system information [e.g., master information block, MIB, and/or system information block one, SIB-1] in order to access the second part of the network.

In embodiments, the first part of the system information [e.g., master information block, MIB, and/or system information block one SIB-1] of the second part of the network includes beam specific information, wherein the second part of the system information [e.g., master information block, MIB, and/or system information block one, SIB-1] of the second part of the network includes non-beam specific information.

In embodiments, the beam specific information includes one or more out of synchronization signal block, SSB, positions-in-burst, random access control channel, RACH, time information and random access control channel, RACH, frequency information.

In embodiments, the beam specific information is transmitted via an extension of the master information block, MIB, or on a downlink control information, DCI, in the common physical downlink control channel, PDCCH, signaling, or on a physical downlink shared channel.

In embodiments, the user equipment is configured to receive first part of the system information [e.g., master information block, MIB, and/or system information block one, SIB-1] of the second part of the network by receiving a beam of a plurality of different beams by means of which the first part of the system information is transmitted.

In embodiments, the user equipment is configured to select the beam out of the plurality of different beams based on SSB measurements of the plurality of different beams.

In embodiments, the second part of the system information [e.g., master information block, MIB, and/or system information block one SIB-1] of the second part of the network includes a timing information for at least one synchronization signal block, SSB, of the second part of the network.

In embodiments, the second part of the system information [e.g., master information block, MIB, and/or system information block one SIB-1] of the second part of the network includes a correspondence of the timing information for at least one synchronization signal block, SSB, of the second part of the network with synchronization signal block, SSB, positions in burst.

In embodiments, the second part of the system information [e.g., master information block, MIB, and/or system information block one SIB-1] of the second part of the network includes a correspondence of the timing information for at least one synchronization signal block, SSB, of the second part of the network with a list of random access channel, RACH, configurations where the same beamforming direction can be assumed.

In embodiments, the user equipment is configured to receive second part radio resource management assistance information, wherein the second part radio resource management assistance information describes radio resource management information of the second part of the network, wherein the user equipment is configured to access the second part of the network based on the second part radio resource management assistance information.

In embodiments, the radio resource management information of the second part of the network includes one or more out of
a reference signal configuration of the second part of the network,
E-UTRA absolute radio frequency channel number, EARFCN, and a number of resource blocks,
an ID of the second part of the network,
a time alignment offset between the first part of the network and the second part of the network,
at least one parameter for frequency correction.

Embodiments provide a method for operating a base station [e.g., gNB] for a [e.g., 5G/NR] wireless communication network. The method comprises a step of serving a first part of the network [e.g., anchor cell]. The method comprises a step of transmitting a second part access information [e.g., x-MSI] for enabling a user equipment to access a second part of the network [e.g., non-anchor cell].

Embodiments provide a method for operating a user equipment for a [e.g., 5G/NR] wireless communication network. The method comprises a step of receiving from a base station on a first part of the network a second part access information [e.g., x-MSI], wherein the second part access information enables the UE to access the second part of the network.

In embodiments, the multi-cell case is considered, where access (e.g., directly or indirectly) to a non-anchor cell is desired. In embodiments, the anchor cell can send access information for one or more or all associated non-anchor cells.

In embodiments, the anchor cell can provide an indication that information for other cells is available.

In embodiments, the anchor cell can optionally provide an indication of whether access via the anchor cell or non-anchor cell is advantageous.

In embodiments, for each non-anchor cell, a received signal power (e.g., RSRP) threshold can be provided such that the direct access via non-anchor cell is only to be performed if the received power is above a certain threshold. For example, the threshold can be based solely on measurement of the received signal power of the anchor cell. This can be an advantageous embodiment for SSB-less operation of the non-anchor cell. For example, the threshold also can be based solely on the received signal power of the non-anchor cell or it may include both. In the case it includes both, the threshold can be based on the difference between the received signal power in the anchor cell and the non-anchor cell.

In embodiments, the information to access the non-anchor cell can be named herein cross-carrier minimum system information (x-MSI).

In embodiments, the x-MSI may contain, for example, information which is typically found on MIB and SIB-1, as well as timing and frequency information for SSBs on non-anchor cell.

The timing can be, for example, a relative offset in slots and/or symbols relative to the frame on the anchor cell and/or periodicity. The frequency information may be, for example, the GSCN and/or ARFCN of the SSB on non-anchor cell.

In embodiments, x-MSI may be transmitted at a lower power than the regular SIB-1. The anchor cell may signal to the UE the difference in transmit power between the regular SIB-1 and x-MSI, or SSB and x-MSI or PBCH and x-MSI.

In some embodiments, it is possible that part of the access information for a non-anchor cell is sent on the anchor cell and another part on the non-anchor cell itself.

In some embodiments, it is possible that the difference between an anchor-cell MSI and the non-anchor cell MSI is sent in the x-MSI/as x-MSI (e.g., differential encoding, delta-information).

In embodiments, the information sent on anchor and non-anchor cell (e.g., two carriers) may follow three different cases, as subsequently described.

A first case is a SSB-less operation (of the non-anchor cell). On a SSB-less operation (of the non-anchor cell) (e.g., SSB-less mode of operation), the non-anchor cell can only send reduced system information, e.g., synchronization signals for discovery and/or radio resource management (RRM) measurements. These may be, for example, tracking reference signal (TRS) or a simplified SSB, e.g., composed of PSS and SSS only. Optionally, this reduced system information can be broadcast with extended periodicity to allow the non-anchor cell to extend its sleep mode. The anchor cell can send all remaining information, i.e., x-MSI, e.g., may include both MIB and SIB-1. In this case, the following steps can be performed by the UE:
1. The UE can read SI on anchor cell and obtain an indication of existence of one or more non-anchor cells
2. The UE can evaluate the criteria to decide on which cell the access is preferred: at the anchor cell or another (non-anchor) cell.
   a. If the access is performed (e.g., done) via anchor cell, the regular initial access procedure can be followed, i.e. the UE can obtain MSI on anchor cell, camp on anchor cell and perform random access procedure on anchor cell, when needed.
   b. If instead the access is performed (e.g., done) via a non-anchor cell, the UE can obtain x-MSI on anchor cell and can perform the random access procedure on the non-anchor cell using the parameters obtained in x-MSI.

A second case is a SIB-1-less operation (of non-anchor cell) (e.g., SIB-1-less mode of operation). On a SIB-1-less operation (of non-anchor cell), the non-anchor cell can broadcast SSBs regularly, but SIB-1 can be obtained as x-MSI on the anchor carrier. In this case, the access may start on either carrier:
1. The UE can evaluate the criteria to decide where the access is preferred: at the anchor cell or another (non-anchor) cell.
   a. If the access is performed (e.g., done) via anchor cell, the regular initial access procedure can be followed, for example, the UE can obtain MSI on anchor cell, camp on anchor cell and perform random access procedure on anchor cell, when needed.
   b. If instead the access is performed (e.g., to be done) via a non-anchor cell, the procedure may differ depending on whether the UE first detects the SSB of anchor cell or the SSB of the non-anchor cell:
      If the UE first detects the SSB of the anchor cell, the UE can obtain x-MSI (at least SIB-1) on anchor cell, then the UE can synchronize to the SSB on non-anchor cell and decode MIB. By combining the MIB information obtained on non-anchor cell with the SIB-1 information obtained from the anchor cell (in x-MSI), the UE can perform random access procedure on the non-anchor cell directly.
      If instead the UE first detects the SSB on the non-anchor cell, the SSB can comprise (e.g., contain) an indication on which frequency (e.g., GSCN, ARFCN) the anchor cell can be found. Optionally, the SSB can comprise (e.g., contain) an extra indication indicating that the anchor cell will transmit (e.g., have) an x-MSI, or it can be simply relied on the existing mechanism for NCD-SSBs to signal for special values of K_ssb a GSCN offset where MSI can be found. Then, the UE can re-synchronize to the anchor cell frequency to obtain x-MSI. By combining the MIB information obtained on non-anchor cell with the SIB-1 information obtained from the anchor cell (in x-MSI), the UE can perform random access procedure on the non-anchor cell directly.
2. Optionally, the SSB on a non-anchor cell may be broadcast with extended periodicity to allow the non-anchor cell an extended “energy saving” mode. The (extended) periodicity of SSB transmission of non-anchor cells may be provided within the SI of the anchor cell.

A third case is a hybrid operation. On a hybrid operation, the non-anchor cell broadcast SSBs and a partial information of SIB-1. The remaining parts of SIB-1 can be obtained on x-MSI in the anchor cell (this embodiment is further elaborated below in section 4). Similar to the cases of SIB-1-less operation described above, it can be possible that the UE starts detecting the SSB on anchor cell or in non-anchor cell and in either case the UE can need to fetch information from both cells to start a random access procedure.

Subsequently, further embodiments and diverse aspects are described.

### 1. x-MSI Signaling and Energy Efficient Multiplexing

Particularly, in the case that x-MSI is broadcast such operation may lead to excessive energy consumption and traffic load on the anchor cell, negating the benefits of having non-anchor cells.

To counteract this effect, in some embodiments, the x-MSI can be transferred at the same time as SIB-1 for anchor cell, but using different resource blocks (RBs). This frequency domain multiplexing can be advantageous as the energy efficiency is higher than when using time multiplexing. This frequency domain multiplexing of SIB-1 and x-MSI may be accomplished in three different levels:
While SIB-1 (for anchor cell) is transmitted on the initial bandwidth part (BWP), x-MSI can be sent on another BWP. As the typical associated behavior for a UE is to have a single BWP active at a time, this would imply that the UE, after receiving the regular SIB-1 on anchor cell, switches the BWP to receive x-MSI and waits for the next opportunity. In other words, in this case, while the network performs (e.g., does) frequency multiplexing of SIB-1 and x-MSI, from a UE perspective, this is done in different points in time.
The x-MSI can be sent also on the initial BWP but it uses a different search space (not searchSpaceSIB1), for example, searchSpaceCrossCarrierSI.
The x-MSI can be sent on searchSpaceSIB1 and even uses the same granting as SIB-1, but the DCI_1_0 for SI-RNTI is modified to contain an indication that x-MSI is sent on adjacent RBs.

The latter is explained in further detail. In the downlink resource allocation type 1 [2], the DCI contains a resource indication value (RIV) which allows to determine a start RB, RB_{START}, and a number of contiguous RBs, L_{RBs}. When x-MSI is sent linked to SIB-1 then bits on DCI_1_0 may be assigned to inform the UE that x-MSI is sent on L_{RBs} to the SIB-1 allocation. This assignment may be configured by RRC, e.g., on SIB-1 or other SIB. As an example, if DCI_1_0 (with SI-RNTI) indicates SIB-1 is on the (closed) bit interval [RB_{START}, RB_{START}+L_{RBs}−1], then one bit may indicate whether there is x-MSI on the RBs in the closed interval [RB_{START}+L_{RBs}, RB_{START}+2*L_{RBs}−1] and another bit may indicate whether there is x-MSI on RBs in the closed interval [RB_{START}−L_{RBs}, RB_{START}−1].

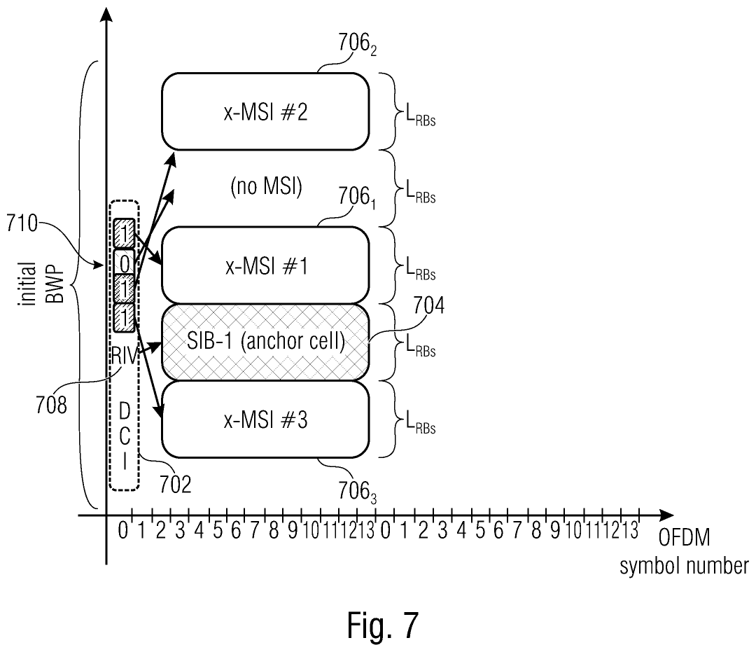

This is exemplified in FIG. 7, which shows an example of SIB-1 704+x-MSI 706₁-706₃ allocation with a single DCI 702. RIV 708 indicates the frequency domain allocation of SIB-1 704 and relative to it previously configured bits indicate whether or not x-MSI 706₁-706₃ can be found on blocks.

In FIG. 7, by way of example, four bits 710 are assigned to indicate whether x-MSI blocks 706₁-706₃ are scheduled together with SIB-1 704 or not. In this example, the blocks follow the same size as the SIB-1 allocation L_{RBs}. Three bits are assigned to indicate x-MSI on the RBs above the SIB-1 allocation (RB_{START} to RB_{START}+L_{RBs}−1) and 1 bit is assigned to indicate x-MSI on the RBs directly below the SIB-1 allocation.

In the example of FIG. 7, bit 0 is used to indicate that a certain block (of L_{RBs}) carrying x-MSI is not scheduled in this DCI and 1 to indicate that a block (of L_{RBs}) carrying x-MSI is scheduled. In other embodiments, the opposite encoding may be used. Namely, that a bit on DCI indicates with a value of 1 that the block is omitted and a value of 0 indicates that it is not omitted (scheduled).

### 2. Differential or Partial SIB-1 Transmission on Anchor Cell

In this embodiment, the anchor cell does not transmit the complete SIB-1 for non-anchor cells. Instead, the anchor cell only transmits those fields of the x-MSI/SIB-1 of the non-anchor cells, which are different from the SIB-1 of the anchor cell itself. Particularly, in the case where there is a lot of commonality between the SIB-1 of anchor cell and SIB-1 of non-anchor cells, this may lead to much less overhead and energy consumption of having x-MSI transmitted in the anchor cell to support direct access to SSB-less and SIB-1-less operation of non-anchor cells.

This can be accomplished in different ways:
The ASN.1 of x-MSI can be defined to be the same as SIB-1 but all fields (or nearly all fields) are made optional.
   If a field is signaled on x-MSI the value signaled on x-MSI is used.
   If a field is not signaled on the x-MSI, the UE can check whether the field was transmitted at SIB-1 from the anchor cell.
      If the field was present on SIB-1 of anchor cell, the value of SIB-1 of anchor cell can be used also for non-anchor cell.
      If the field was also not present on SIB-1 of anchor cell, then UE processing can continue considering that this field is not present on SIB-1 of the non-anchor cell (note this is only applicable to SIB-1 fields which are optional).
   A few fields may still be made mandatory (signaled for x-MSI) as they are expected to be different from the anchor cell. One example is the CellAccessRelatedInfo, which includes cellIdenty, and for that reason could be included or for example only cellIdentity is made mandatory in ASN.1 of x-MSI and other fields are made optional.
Each field on SIB-1 can be assigned an index. Then, x-MSI can be defined to have a list of index/values. Only the fields which differ from SIB-1 of anchor cell are put to the list. Each non-anchor cell may have its own list of index/values.

If a set of parameters is common to multiple non-anchor cells (e.g., all non-anchor cells), this block can be sent only once and associated to the corresponding non-anchor cells. In this case, the information of each non-anchor cell can be obtained as:
fields which are equal to SIB-1 on anchor cell,
fields which are different than SIB-1 on anchor cell, but shared among multiple non-anchor cells, or
fields which are different than SIB-1 on anchor cell and individually signaled per non-anchor cell.

The usage of differential encoding described in this section is highly beneficial if x-MSI is SIB-1, but in other embodiments the same approach can be used if x-MSI is not just SIB-1 (e.g., if x-MSI is MIB+SIB-1) or less than SIB-1 (e.g., a subset of SIB-1).

### 3. Cross-Carrier SI Using Other-SI on Anchor Carrier

In this embodiment, SIB-1 for another carrier, e.g., non-anchor cell, is not broadcast regularly, but it can be accessed on the anchor cell via the mechanism of on-demand other-SI. In order to acquire x-MSI, the UE can monitor the search space for other SI.

For this sake, in embodiments, the following approaches can be considered:
Each xMSI can be configured for different request resources (e.g., via an SI-RequestConfig resource for each non anchor cell).
xMSI for non-anchor cells may only be broadcast on specific conditions, e.g., on load or signal strength condition(s) of the anchor cell.
   For example, only of a threshold indicating the load of the anchor cell is passed the xMSI of one or multiple anchor cell(s) may be broadcast.
   Alternatively, the signal strength (e.g., RSRP) of the anchor and/or non-anchor cells may be considered to broadcast xMSI of non-anchor cells. For example, in case the RSS (e.g., RSRP) of the anchor cell falls below a defined threshold or in case the RSS of a non-anchor cell exceeds the RSS of the anchor cell by a defined extent.
A SIB container (e.g., SIB-XY) can include xMSI from all other cells. A single resource (e.g., an SI-RequestConfig) can be present so that UE can request if SIB-XY is on notBroadcasting status.

Naturally, multiple containers are also possible. For example, one container for SIB-1 of anchor cells on, e.g., FR1 and another container for SIB-1 of anchor cells on, e.g., FR2. In this case, depending on UE capability the UE may decide to only obtain x-MSI for FR1 but not FR2 or FR2 only but not FR1.

### 4. Hybrid SIB-1

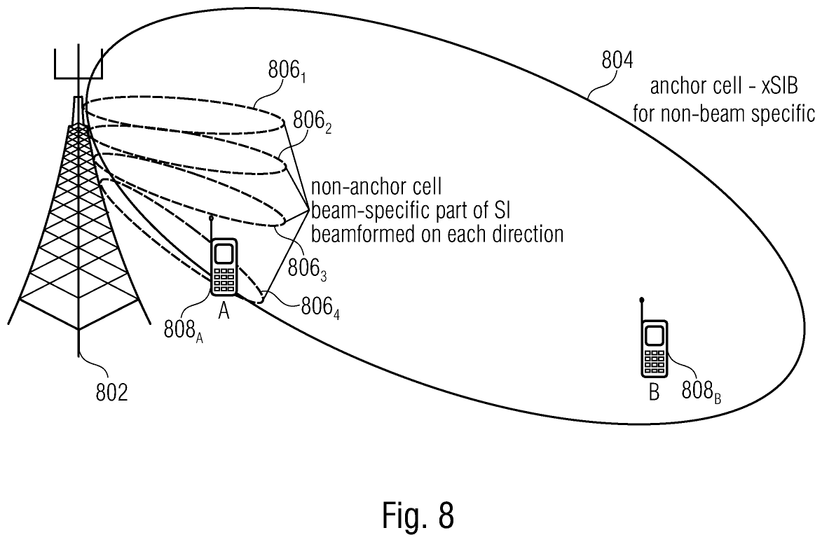

In this embodiment, a hybrid approach is considered, where some of the information (e.g., a first part of the information) to access the non-anchor cell is transmitted on anchor cell and some of the information (e.g., a second part of the information) is transmitted on non-anchor cell. This approach can be advantageous, for example, when the anchor cell is on FR1 and the non-anchor cell is on FR2, but it may also be considered in other cases. In a co-deployment of FR1 and FR2 the coverage of FR1 will typically be much larger than FR2 and the number of beams on FR2 can be much larger than in FR1. Because of that, there may be no direct coverage correspondence between FR1 and FR2 beams, as shown in FIG. 8.

In detail, FIG. 8 shows a schematic representation of a hybrid operation where part of the SIB-1 information (of non-anchor cell) is sent on anchor cell, but another part which is specific to each beam is sent directly on non-anchor cell—beamformed on each direction. As shown in FIG. 8, a base station 802 can use a first beam 804 for serving an anchor cell (e.g., on FR1), and a plurality of different beams 806₁-806₄ for serving a non-anchor cell, where a part of the SI that is specific to each beam is sent directly on non-anchor cell-beamformed on each direction.

In embodiments, the anchor cell can carry most of the access information of SIB-1 for the non-anchor cell, but the non-anchor cell still can carry information which is beam specific in order to enable beam management. Thus SIB-1 for non-anchor cell can be divided into:
Non-beam specific information, which can be equal in all beams. This information can be sent on anchor cell.
Beam-specific information—hereafter named bs-MSI. This information can be sent directly on non-anchor carrier, and it can be beamformed on each specific direction using a beam sweep which corresponds to the beam sweeping of SSB.

The beam-specific information may contain fields, such as, for example:
SSB-Positions-in-burst,
RACH time information, and/or
RACH frequency information.

The beam specific parameters parameter can be sent on the non-anchor cell (e.g., on FR2) in some different ways, such as, for example:
on an extension of PBCH/MIB,
on DCI in the common PDCCH signaling, and/or
on PDSCH, e.g., a very short time allocation compared to regular SIB-1.

For the sake of initial beam selection the beam specific information can be beamformed. This process is illustrated on FIG. 8, which shows that that UE B 808_{B} receives the SI on the anchor cell and it can determine that it also contains x-MSI. UE B 808_{B} can determine that the RSRP on the anchor cell is below the threshold and it decides that it should perform random access procedure directly on the anchor cell. The UE A 808_{A} instead can read the system information of the anchor cell and it can determine that the RSRP on the anchor cell is above the threshold and therefore, it can perform the random access procedure directly on the non-anchor cell.

In order to perform the random access procedure on the non-anchor cell, the UE can obtain the non-beam specific x-MSI of that cell within the anchor cell. This may, e.g., be done according to the embodiments of sections 1, 2 and/or 3. Also the UE can obtain from the anchor cell more precise frequency information of the SSB on the non-anchor cell (e.g., GSCN), time information of SSB on the non-anchor cell (e.g., SSB periodicity, offset to anchor cell SSB) and physical cell ID of the non-anchor cell. If the UE has all this information it can more quickly scan the target frequency GSCN at the appropriate time an SSB burst will be sent and already configuring the correlator to search for the proper SSS and PSS. As illustrated on FIG. 8, not all SSBs may reach the UE. When the UE detects an appropriate SSB and/or select the best one, instead of attempting to receive SIB-1 (as it knows this is a SIB-1-less cell) the UE can receive the beam-specific bs-MSI beamformed on the same direction as the SSB. The beam-specific bs-MSI information a ssb-Positions-in-Burst field can be included such that the UE can determine exactly which position in the burst and in the frame the corresponding SSB is. In that information, it also can obtain RACH configuration which can be used to start the random access procedure in the proper beamformed direction.

Besides FR1/FR2, the Hybrid SIB-1 can also be divided by categorizing quasi-static (e.g., not changed often) and volatile SIB-1 information (e.g., changed often, e.g., multiple times a day or even multiple times per hour). This might be useful for information about transmissions power, UAC parameters, cell selection info, network slicing configuration or RedCap related configuration. In general every parameter in the MSI could be changed. Due to the update mechanisms (and required paging) a frequent change of the SI of the anchor cell might not be desired due to the negative effect on connected/inactive devices.

### 5. Cross-Carrier Information for SIB-1-Less

As an alternative to the embodiment described in section 4, and in order to achieve completely SIB-1-less operation, in embodiments, the x-MSI transmitted on the anchor cell may include one or more out of:
Detailed timing information for all SSBs of the non-anchor cell (e.g., up to the maximum number of SSBs supported—e.g., 64 on FR2), based on the synchronization and timing obtained in the anchor cell.
Correspondence of this timing information with SSB-positions-in-burst.
Correspondence of this configuration with a list of RACH configurations where the same beamformed direction can be assumed (e.g., in RACH case gNB receiving beamforming).

### 6. RRM Assistance for SSB-Less Operation

When the SSB is not present regularly on the non-anchor cell (e.g., SSB-less operation) or just even very sparse (e.g., very large SSB periodicity) it may become very difficult to use the non-anchor cell because the UE may not be even aware that operation on the non-anchor cell is possible.

For this sake, the anchor cell may broadcast information related to RRM measurements assistance. This information may be sent in addition to x-MSI or as part of x-MSI. This may include, for example, one or more out of:
Reference Signal (RS) configuration, e.g., a Tracking Reference Signal (TRS) or a Discovery Reference Signal (DRS).
EARFCN of point A and number of RBs.
Cell ID.
Time alignment offset between anchor cell and non-anchor cell.
Parameters for frequency correction.

### 7. Further Embodiments

Embodiments described herein provide reduced overhead and reduced energy consumption for the network. Access directly on non-anchor carrier is possible, which leads to simpler and better load balancing.

Embodiments described herein can be implemented in mobile communications systems, such as 5G NR.

Embodiments described herein provide efficient multiplexing and signaling.

Embodiments described herein provide a hybrid operation aware of beam management.

Embodiments described herein provide a differential SIB-1.

Embodiments described herein allow for less energy consumption than what is defined on [1].

Embodiments described herein provide a practical solution to issues on SSB-less and SIB-1-less operation.

Embodiments described herein provide signaling of system information in a reduced way which accomplishes smooth network operation in a way which enables significant energy savings and overhead reduction.

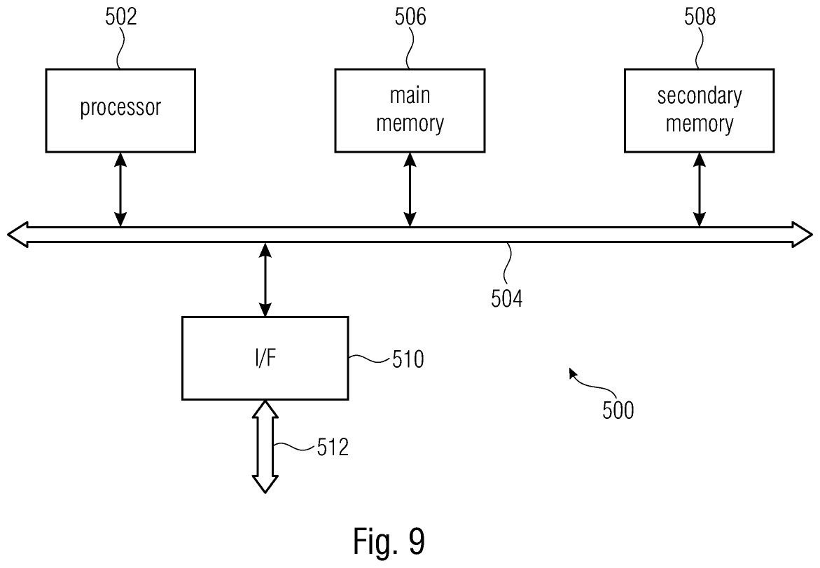

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 9 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are advantageously performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### LIST OF REFERENCES

[1] 3GPP TR 38.864 V18.1.0 (2023-03) Study on network energy savings for NR (Release 18)
[2] 3GPP TR 38.214 V18.0.0 (2023-03) NR; Physical layer procedures for data (Release 18)
[3] 3GPP TS 38.331 V17.6.0 (2023-09) Radio Resource Control (RRC) protocol specification (Release 17)

### ABBREVIATIONS

3GPP third generation partnership project
ACK acknowledgement
ARFCN absolute radio frequency channel number
BFD beam failure detection
BFR beam failure recovery
BRP beam forming resource pool
BWP bandwidth part
BS base station
bs-MSI Beam-specific Minimum System Information
CD-SSB cell-defining synchronization signal block
CDM code division multiplexing
CG configured grant
CRI CSI-RS resource indicator
CQI channel quality indicator
CSI channel state information
CSI-RS channel state information-reference signal
D2D device-to-device
DC dual conectivity
DCI downlink control information
DL downlink
DM-RS demodulation reference signal
DRS discovery reference signal
DRX discontinues reception
DTX discontinues transmission
eNB evolved node B
FR frequency range
FR1 frequency range one
FR2 frequency range two
gNB next generation node B
GSCN global synchronization channel number
HARQ hybrid automatic repeat request
ID identity
IFFT inverse fast Fourier transform
IoT internet of things
LTE long-term evolution
MAC medium access control
MAC-CE medium access control-control element
MCG master cell group
MIB master information block
MSI minimum system information
NACK negative acknowledgement
NCD-SSB non cell-defining synchronization signal block
NES network energy saving
NR new radio
OFDM orthogonal frequency-division multiplexing
OFDMA orthogonal frequency-division multiple access
PBCH physical broadcast channel
PC5 interface using the sidelink channel for D2D communication
PDCCH physical downlink control channel
PDSCH physical downlink shared channel
PMI precoding matrix indicator
PRACH physical random access channel
PRS positioning reference signal
PSBCH physical sidelink broadcast channel
PSCCH physical sidelink control channel
PSFCH physical sidelink feedback channel
PSS primary synchronization signal
PSSCH physical sidelink shared channel
PUCCH physical uplink control channel
PUSCH physical uplink shared channel
QCL quasi-colocation
RACH random access channel
RAN radio access networks
RB resource block
RE resource element
RedCap reduced capability
RMSI remaining minimum system information
RNTI radio network temporary identifier
RRC radio resource control
RS reference signal
RSRP reference signal received power
RSRQ reference signal received quality
RSS received signal strength
SCI sidelink control information
SCG secondary cell group
SI system information
SIB system information block
SL sidelink
SPS semi persistent scheduling
SR scheduling request
SRS sounding reference signal
SSB synchronization signal block
SSS secondary synchronization signal
S-SSB sidelink synchronization signal block
sTTI short transmission time interval
TDD time division duplex
TRS tracking reference signal
UAC unified access channel
UE user equipment, e.g., a smartphone or IoT node
UL uplink
UMTS universal mobile telecommunication system
V2X vehicle-to-everything
V2V vehicle-to-vehicle
x-MSI cross-carrier minimum system information

1. Base station for a wireless communication network,
wherein the base station is configured to serve a first part of the network,
wherein the base station is configured to transmit a second part access information for enabling a user equipment to access a second part of the network.

2. Base station according to claim 1,
wherein the second access information is essential for an initial access of a UE to the second part of the network.

3. Base station according to claim 1,
wherein the second part access information describes at least a part of system information of the second part of the network.

4. Base station according to claim 1,
wherein the first part of the network is at least one out of a first cell, anchor cell, first carrier and first beam,
wherein the second part of the network is at least one out of a second cell, non-achor cell, second carrier and second beam.

5. Base station according to claim 1,
wherein the second part access information describes a timing and/or frequency of a synchronization signal of the second part of the network.

6. Base station according to claim 1,
wherein the base station is configured to transmit a system information of the first part of the network.

7. Base station according to claim 6,
wherein the second part access information describes a difference between
at least the part of the system information of the second part of the network, and
at least a corresponding part of the system information of the first part of the network.

8. Base station according to claim 6,
wherein the base station is configured to transmit the second part access information with a lower transmit power than the system information of the first part of the network.

9. Base station according to claim 6,
wherein the base station is configured to transmit
the second cell access information, and
the system information of the first part of the network using frequency domain multiplexing.

10. Base station according to claim 9,
wherein the base station is configured to transmit
the system information of the first part of the network in a first bandwidth part, and
the second cell access information using a second bandwidth part, different from the first bandwidth part.

11. Base station according to claim 9,
wherein the base station is configured to transmit
the system information of the first cell, and
the second cell access information
on the same bandwidth part, but using different search spaces.

12. Base station according to claim 9,
wherein the base station is configured to transmit a downlink control information, DCI, indicating a group of resource blocks used for transmitting
the system information of the first part of the network, and
the second part access information.

13. Base station according to claim 12,
wherein the downlink control information, DCI, indicates the group of resource blocks by means of a start resource block and a number of contiguous resource blocks of the group of resource blocks.

14. Base station according to claim 12,
wherein the downlink control information, DCI, comprises an indication that the second cell access information is transmitted on one of the resource blocks of the group of resource blocks.

15. Base station according to claim 12,
wherein a presence or absence of a subset of resource blocks is indicated by means of a one bit indication.

16. Base station according to claim 1,
wherein the second part access information describes the information of the system information of the second part of the network, which is different from the system information of the first part of the network.

17. Base station according to claim 1,
wherein the second part access information describes at least a part of a system information of at least two different second parts of the network,
wherein the second part access information describes the information of the system information of the at least two different second parts of the network, which are different from the system information of the first part of the network.

18. Base station according to claim 17,
wherein the second part access information describes the information that is common to the system information of the at least two different second parts of the network only once.

19. Base station according to claim 1,
wherein the base station is configured to transmit the second part access information in response to a second part access information transmission request and/or in case that a second part access information transmission criterion is fulfilled.

20. Base station according to claim 19,
wherein the second part access information transmission criterion is fulfilled in case that at least one out of
a load of the first part of the network reaches a predefined load condition,
a signal strength of the first part of the network and/or second part of the network reaches a predefined signal strength condition.

21. Base station according to claim 1,
wherein the base station is configured to serve the second part of the network,
wherein the base station is configured to operate the second part of the network in an energy saving mode of operation,
wherein in the energy saving mode of operation the system information of the second part of the network is not transmitted or transmitted only partially in the second part of the network.

22. Base station according to claim 21,
wherein the base station is configured to operate the first part of the network in one out of frequency range one, FR1, and frequency range two, FR2,
wherein the base station is configured operate the second part of the network in the other one out of frequency range one, FR1, and frequency range two, FR2.

23. Base station according to claim 1,
wherein the second part access information is transmitted as part of a container.

24. Base station according to claim 1,
wherein the second part access information is a system information block.

25. Base station according to claim 1,
wherein the base station is configured to transmit a second part access information transmission request configuration information allowing a user equipment to transmit a second part access information transmission request.

26. Base station according to claim 1,
wherein the base station is configured to transmit a first part of the system information of the second part of the network in the second part of the network,
wherein the second part access information describes a second part of the system information of the second part of the network.

27. Base station according to claim 26,
wherein the first part of the system information of the second part of the network comprises beam specific information,
wherein the second part of the system information of the second part of the network comprises non-beam specific information.

28. Base station according to claim 26,
wherein the base station is configured transmit the first part of the system information of the second part of the network using a beam sweep.

29. Base station according to claim 27,
wherein the beam specific information comprises one or more out of synchronization signal block, SSB, positions-in-burst, random access control channel, RACH, time information and random access control channel, RACH, frequency information.

30. Base station according to claim 27,
wherein the beam specific information is transmitted via an extension of the master information block, MIB, or on a downlink control information, DCI, in the common physical downlink control channel, PDCCH, signaling, or on a physical downlink shared channel.

31. Base station according to claim 26,
wherein the second part of the system information of the second part of the network comprises a timing information for at least one synchronization signal block, SSB, of the second part of the network.

32. Base station according to claim 31,
wherein the second part of the system information of the second part of the network comprises a correspondence of the timing information for at least one synchronization signal block, SSB, of the second part of the network with synchronization signal block, SSB, positions in burst.

33. Base station according to claim 31,
wherein the second part of the system information of the second part of the network comprises a correspondence of the timing information for at least one synchronization signal block, SSB, of the second part of the network with a list of random access channel, RACH, configurations where the same beamforming direction can be assumed.

34. Base station according to claim 1,
wherein the base station is configured to transmit second part radio resource management assistance information for enabling a user equipment to access a second part of the network,
wherein the second part radio resource management assistance information describes radio resource management information of the second part of the network.

35. Base station according to claim 34,
wherein the radio resource management information of the second part of the network comprises one or more out of
a reference signal configuration of the second cell,
E-UTRA absolute radio frequency channel number, EARFCN, and a number of resource blocks,
an ID of the second cell,
a time alignment offset between the first cell and the second cell,
at least one parameter for frequency correction.

36. User equipment for a wireless communication network,
wherein the user equipment is configured to receive from a base station on a first part of the network a second part access information,
wherein the second part access information enables the UE to access the second part of the network.

37. User equipment according to claim 36,
wherein the second access information is essential for an initial access of the user equipment to the second part of the network.

38. User equipment according to claim 36,
wherein the second part access information describes at least a part of a system information of the second part of the network.

39. User equipment according to claim 36,
wherein user equipment is configured to access the second part of the network based on the second part access information.

40. User equipment according to claim 36,
wherein the user equipment is configured to receive from the base station on the first part of the network a system information of the first part of the network.

41. User equipment according to claim 40,
wherein the second part access information describes a difference between
at least the part of the system information of the second part of the network, and
at least a corresponding part of the system information of the first part of the network.

42. User equipment according to claim 40,
wherein the second part access information is transmitted with a lower transmit power than the system information of the first part of the network.

43. User equipment according to claim 36,
wherein the user equipment is configured to access the first part of the network or the second part of the network in dependence on an access criterion.

44. User equipment according to claim 43,
wherein the access criterion is one out of
a received signal power of the first part of the network,
a received signal power of the second part of the network,
a difference between a received signal power of the first part of the network and a received signal power of the second part of the network.

45. User equipment according to claim 36,
wherein the first part of the network is a first cell, first carrier and/or first beam,
wherein the second part of the network is a second cell, second carrier and/or second beam.

46. User equipment according to claim 40,
wherein the user equipment is configured to receive
the second part access information, and
the system information of the first part of the network
using frequency domain multiplexing.

47. User equipment according to claim 46,
wherein the user equipment is configured to receive
the system information of the first part of the network in a first bandwidth part, and
the second part access information using a second bandwidth part, different from the first bandwidth part.

48. User equipment according to claim 46,
wherein the user equipment is configured to receive
the system information of the first part of the network, and
the second part access information
on the same bandwidth part, but using different search spaces.

49. User equipment according to claim 46,
wherein the user equipment is configured to receive a downlink control information, DCI, indicating a group of resource blocks used for transmitting
the system information of the first part of the network, and
the second part access information.

50. User equipment according to claim 49,
wherein the downlink control information, DCI, indicates the group of resource blocks by means of a start resource block and a number of contiguous resource blocks of the group of resource blocks.

51. User equipment according to claim 49,
wherein the downlink control information, DCI, comprises an indication that the second part access information is transmitted on one of the resource blocks of the group of resource blocks.

52. User equipment according to claim 49,
wherein a presence or absence of a subset of resource blocks is indicated by means of a one bit indication.

53. User equipment according to claim 36,
wherein the second part access information describes the information of the system information of the second part of the network, which is different from the system information of the first part of the network.

54. User equipment according to claim 36,
wherein the second part access information describes at least a part of a system information of at least two different second parts of the network,
wherein the second part access information describes the information of the system information of the at least two different second parts of the network, which are different from the system information of the first part of the network.

55. User equipment according to claim 54,
wherein the second part access information describes the information that is common to the system information of the at least two different second parts of the network only once.

56. User equipment according to claim 36,
wherein the user equipment is configured to transmit to the base station on the first part of the network a second part access information transmission request,
wherein the user equipment is configured to receive the second part access information in response to the transmission of the second part access information transmission request.

57. User equipment according to claim 36,
wherein the second part access information is transmitted as part of a container.

58. User equipment according to claim 36,
wherein the second part access information is a system information block.

59. User equipment according to claim 36,
wherein the user equipment is configured to receive a second part access information transmission request configuration information,
wherein the user equipment is configured to transmit to the base station on the first part of the network a second part access information transmission request in dependence on the second part access information transmission request configuration information.

60. User equipment according to claim 36,
wherein the second part access information describes a second part of the system information of the second part of the network,
wherein the user equipment is configured to receive a first part of the system information of the second part of the network in the second part of the network.

61. User equipment according to claim 60,
wherein the user equipment is configured to combine the first part of the system information of the second part of the network and the second part of the system information in order to access the second part of the network.

62. User equipment according to claim 60,
wherein the first part of the system information of the second part of the network comprises beam specific information,
wherein the second part of the system information of the second part of the network comprises non-beam specific information.

63. User equipment according to claim 62,
wherein the beam specific information comprises one or more out of synchronization signal block, SSB, positions-in-burst, random access control channel, RACH, time information and random access control channel, RACH, frequency information.

64. User equipment according to claim 62,
wherein the beam specific information is transmitted via an extension of the master information block, MIB, or on a downlink control information, DCI, in the common physical downlink control channel, PDCCH, signaling, or on a physical downlink shared channel.

65. User equipment according to claim 61,
wherein the user equipment is configured to receive first part of the system information of the second part of the network by receiving a beam of a plurality of different beams by means of which the first part of the system information is transmitted.

66. User equipment according to claim 65,
wherein the user equipment is configured to select the beam out of the plurality of different beams based on SSB measurements of the plurality of different beams.

67. User equipment according to claim 60,
wherein the second part of the system information of the second part of the network comprises a timing information for at least one synchronization signal block, SSB, of the second part of the network.

68. User equipment according to claim 67,
wherein the second part of the system information of the second part of the network comprises a correspondence of the timing information for at least one synchronization signal block, SSB, of the second part of the network with synchronization signal block, SSB, positions in burst.

69. User equipment according to claim 67,
wherein the second part of the system information of the second part of the network comprises a correspondence of the timing information for at least one synchronization signal block, SSB, of the second part of the network with a list of random access channel, RACH, configurations where the same beamforming direction can be assumed.

70. User equipment according to claim 36,
wherein the user equipment is configured to receive second part radio resource management assistance information,
wherein the second part radio resource management assistance information describes radio resource management information of the second part of the network,
wherein the user equipment is configured to access the second part of the network based on the second part radio resource management assistance information.

71. User equipment according to claim 70,
wherein the radio resource management information of the second part of the network comprises one or more out of
a reference signal configuration of the second part of the network,
E-UTRA absolute radio frequency channel number, EARFCN, and a number of resource blocks,
an ID of the second part of the network,
a time alignment offset between the first part of the network and the second part of the network,
at least one parameter for frequency correction.

72. Method for operating a base station for a wireless communication network, the method comprising:
serving a first part of the network,
transmitting a second part access information for enabling a user equipment to access a second part of the network.

73. Method for operating a user equipment for a wireless communication network, the method comprising:
receiving from a base station on a first part of the network a second part access information,
wherein the second part access information enables the UE to access the second part of the network.

74. Non-transitory digital storage medium having a computer program stored thereon to perform the method of claim 72 when said computer program is run by a computer.

75. Non-transitory digital storage medium having a computer program stored thereon to perform the method of claim 73 when said computer program is run by a computer.
